(19) United States
(12) Patent Application Publication
(10) Pub. No.: US 2013/0282328 A1
(43) Pub. Date: Oct. 24, 2013

(54) ERROR MEASURMENT DEVICE AND ERROR MEASUREMENT METHOD

(71) Applicants: Ryuta Sato, Chiyoda-ku (JP); Yukihiro Iuchi, Chiyoda-ku (JP); Shunro Ono, Chiyoda-ku (JP)

(72) Inventors: Ryuta Sato, Chiyoda-ku (JP); Yukihiro Iuchi, Chiyoda-ku (JP); Shunro Ono, Chiyoda-ku (JP)

(73) Assignee: MITSUBISHI ELECTRIC CORPORATION, Chiyoda-ku, Tokyo (JP)

(21) Appl. No.: 13/977,781

(22) PCT Filed: Jan. 24, 2011
(86) PCT No.: PCT/JP2011/051236

§ 371 Date: Jul. 1, 2013

(51) Int. Cl. G05B 19/401

(52) U.S. Cl. CPC G05B 19/401
USPC 702/150

(57) ABSTRACT

The present invention has a rotation-axis geometric-deviation measuring step of measuring a position and a tilt of a rotation-axis center line by measuring a position of a point on a surface of a workpiece fixed to a rotation axis, a geometric-deviation-parameter setting step of setting a correction amount of the measured position and tilt of the rotation-axis center line in a numerical control device, a workpiece-installation-error measuring step of measuring an installation position and a tilt of the workpiece with reference to the position of the rotation-axis center line, and a workpiece-installation-error parameter setting step of setting the measured installation position and tilt of the workpiece in the numerical control device, and accordingly enables measurement of a position and a tilt of the rotation axis center by measuring the position of a point on the workpiece surface in a state where the workpiece is fixed to the rotation axis.

### FIELD

The present invention relates to an error measurement device and an error measurement method that measure errors, such as a position and a tilt of a rotation-axis center line and an installation position and a tilt of a workpiece, in a multi-axis machine tool, such as a five-axis control machining center.

### BACKGROUND

For example, a numerical control device of a multi-axis machine tool represented, for example, by a five-axis control machining center has a function to correct influences of an installation position and a tilt of a workpiece installed on a work table, and a function to correct influences of a position and a tilt of a rotation-axis center line. To effectively utilize these functions, it is necessary to accurately measure the position and the tilt of the workpiece or the rotation-axis center line and to appropriately set the measured position and tilt in a correction-value setting area of the control device as parameters.

Patent Literature 1 discloses a method of detecting positions of three points on each of three faces perpendicular to each other of a cuboid workpiece installed on a work table with a touch probe, obtaining three expressions each representing a plane passing through three points based on three points in a same plane, and obtaining a position of a point O′ where the three planes intersect with each other, as well as obtaining a point located at a length L from the point O′ where the three planes intersect with each other and obtaining a rotation matrix based on a coordinate of the point O′ and the length L, thereby acquiring a tilt of the workpiece. With this approach, the installation position and the tilt of the workpiece can be measured.

Furthermore, Patent Literature 2 discloses a method of installing a reference sphere (master sphere) at a predetermined position on a work table, obtaining a central coordinate of the reference sphere in a state where a rotation axis thereof is rotated an arbitrary angle, and obtaining a central coordinate of the reference sphere in a state where the rotation axis is further rotated the predetermined angle (in a state where the rotation axis is indexed by the predetermined angle) to obtain a rotation center coordinate of the work table through computation based on the two central coordinates and the index angle.

Further, Non Patent Literature 1 discloses a method of automatically measuring a central coordinate of a reference sphere installed on a work table using a touch probe with a rotation axis thereof being indexed by a predetermined angle and also identifying a perpendicularity between two translation axes as well as a position and a tilt of a rotation-axis center line.

### CITATION LIST

### Patent Literatures

Patent Literature 1: Japanese Patent Application Laid-open No. 2006-289524
Patent Literature 2: Japanese Patent Application Laid-open No. 2007-44802

### Non Patent Literatures

Non Patent Literature 1: Tetsuya MATSUSHITA, Tadahiro OKI: Identification of geometric errors in five-axis control machine tool using touch probe, Collection of Conference Papers in Academic Conference of The Japan Society for Precision Engineering 2010, Spring Meeting (2010), pp. 1105-1106
Non Patent Literature 2: Japan Machine Tool Builders' Association: Handout of Briefing Session on Standardization of Accuracy Test for Five-axis control machining center (2008)

### SUMMARY

### Technical Problem

When influences of an installation position and a tilt of a workpiece installed on a work table are to be corrected by a numerical control device, a rotation axis is operated to correct the influence of the tilt of the workpiece even when the rotation axis is not moved by an NC program. In this case, when influences of a position and a tilt of the rotation-axis center line are not corrected correspondingly, a machining accuracy is deteriorated. However, with the method described in Patent Literature 1, there is a problem that, while an installation position and a tilt of a workpiece can be measured, a position and a tilt of a rotation-axis center line cannot be measured.

When influences of an installation position and a tilt of a workpiece in a multi-axis machine tool of a type having a rotation axis on the side of a table are to be corrected, the installation position of the workpiece is often represented as a relative position with reference to a position of the rotation-axis center line and is input to a numerical control device. At that time, when the position of the rotation-axis center line is not accurately recognized by an operator or a numerical control device, the installation position of the workpiece cannot be accurately set in the numerical control device. With the method described in Patent Literature 1, the position of the rotation-axis center line cannot be measured and thus there is no alternative but to set the installation position of the workpiece as a value with reference to a rotation-axis center line previously set. As a result, there is a problem that the influence of the installation position of the workpiece cannot be properly corrected.

Furthermore, because the position and the tilt of the rotation-axis center line in a multi-axis machine tool vary, for example, according to a mass or a temperature of a workpiece, it is desirable that the position and the tilt can be measured immediately before machining in a state where the workpiece is installed on a work table. However, because a reference sphere needs to be installed on a work table in the method disclosed in Patent Literature 2 or Non Patent Literature 1, there is a problem that the position and the tilt of the rotation-axis center line cannot be measured in the state where the workpiece is installed, and accordingly the position and the tilt of the center line during actual machining cannot be properly corrected.

The present invention has been achieved in view of the above problems, and an object of the present invention is to provide an error measurement device and an error measurement method that can accurately measure a position and a tilt of a rotation center line even when the position and the tilt of the rotation center line vary according to a change in a mass or a temperature of a workpiece, and can also accurately measure an installation position of the workpiece as a relative displacement from a rotation-axis center line.

### Solution to Problem

In order to solve above-mentioned problems and achieve the object of the present invention, according to an aspect of the present invention, there is provided an error measurement device that measures a position and a tilt of a rotation-axis center line and an installation position and a tilt of a workpiece in a numerical-control machine tool having a translation axis and a rotation axis, the error measurement device including: a rotation-axis geometric-deviation measurement unit that measures a position and a tilt of the rotation-axis center line by measuring a position of a point on a surface of the workpiece fixed; a geometric-deviation-parameter setting unit that sets the measured position and tilt of the rotation-axis center line in a numerical control device; a workpiece-installation-error measurement unit that measures an installation position and a tilt of the workpiece with reference to the position of the rotation-axis center line; and a workpiece-installation-error parameter setting unit that sets the measured installation position and tilt of the workpiece in a numerical control device.

According to another aspect of the present invention, there is provided an error measurement device that measures a position of a rotation-axis center line and an installation position and a tilt of a workpiece in a numerical-control machine tool having a translation axis and a rotation axis, the error measurement device including: a rotation-center-position measurement unit that measures a position of the rotation-axis center line by measuring a position of a point on a surface of the workpiece; a rotation-center-parameter setting unit that sets the measured position of the rotation-axis center line in a numerical control device; a workpiece-installation-error measurement unit that measures an installation position and a tilt of the workpiece with reference to the position of the rotation-axis center line; and a workpiece-installation-error parameter setting unit that sets the measured installation position and tilt of the workpiece in a numerical control device.

According to still another aspect of the present invention, there is provided an error measurement device that measures a position and a tilt of a rotation-axis center line of a rotation axis on which a workpiece is installed in a numerical-control machine tool having a translation axis and a rotation axis, wherein a three-dimensional coordinate of a reference point that is one point on the workpiece and is defined together with a shape of the workpiece is obtained based on a plurality of measurement points on the workpiece decided as points required to specify the three-dimensional coordinate of the reference point, at at least two index angles while indexing the rotation axis by a predetermined angle, and a position and a tilt of a rotation center line of the rotation axis are calculated based on a relationship between the index angles and a plurality of the three-dimensional coordinates of the reference point.

According to still another aspect of the present invention, there is provided an error measurement device that measures a position of a rotation-axis center line of a rotation axis on which a workpiece is installed in a numerical-control machine tool having a translation axis and a rotation axis, wherein a two-dimensional coordinate of a reference point that is one point obtained by projecting the workpiece on a two-dimensional plane perpendicular to the rotation axis and is defined together with a shape of the workpiece is obtained based on a plurality of measurement points on the workpiece that are decided as points required to specify the two-dimensional coordinate of the reference point, at at least two index angles while indexing the rotation axis by a predetermined angle, and a position of a rotation center line of the rotation axis is calculated based on a relationship between the index angles and a plurality of the two-dimensional coordinates of the reference point.

According to still another aspect of the present invention, there is provided an error measurement method of measuring a position and a tilt of a rotation-axis center line of a rotation axis on which a workpiece is installed, and an installation position and a tilt of the workpiece in a numerical-control machine tool having a translation axis and a rotation axis, the error measurement method including: a rotation-axis geometric-deviation measuring step of measuring a position and a tilt of the rotation-axis center line by measuring a position of a point on a surface of the workpiece fixed to the rotation axis; a geometric-deviation-parameter setting step of setting a correction amount of the measured position and tilt of the rotation-axis center line in a numerical control device;

a workpiece-installation-error measuring step of measuring an installation position and a tilt of the workpiece with reference to the position of the rotation-axis center line; and a workpiece-installation-error parameter setting step of setting the measured installation position and tilt of the workpiece in a numerical control device.

According to still another aspect of the present invention, there is provided an error measurement method of measuring a position of a rotation-axis center line of a rotation axis on which a workpiece is installed, and an installation position and a tilt of the workpiece in a numerical-control machine tool having a translation axis and a rotation axis, the error measurement method including: a rotation-center-position measuring step of measuring a position of the rotation-axis center line by measuring a position of a point on a surface of the workpiece fixed to the rotation axis; a rotation-center-parameter setting step of setting a correction amount of the measured position of the rotation-axis center line in a numerical control device; a workpiece-installation-error measuring step of measuring an installation position and a tilt of the workpiece with reference to the position of the rotation-axis center line; and a workpiece-installation-error parameter setting step of setting the measured installation position and tilt of the workpiece in a numerical control device.

According to still another aspect of the present invention, there is provided an error measurement method of measuring a position and a tilt of a rotation-axis center line of a rotation axis on which a workpiece is installed in a numerical-control machine tool having a translation axis and a rotation axis, wherein a three-dimensional coordinate of a reference point that is one point on the workpiece and is defined together with a shape of the workpiece is obtained based on a plurality of measurement points on the workpiece decided as points required to specify the three-dimensional coordinate of the reference point, at at least two index angles while indexing the rotation axis by a predetermined angle, and a position and a tilt of a rotation center line of the rotation axis are calculated based on a relationship between the index angles and a plurality of the three-dimensional coordinates of the reference point.

According to still another aspect of the present invention, there is provided an error measurement method of measuring a position of a rotation-axis center line of a rotation axis on which a workpiece is installed in a numerical-control machine tool having a translation axis and a rotation axis, wherein a two-dimensional coordinate of a reference point that is one point obtained by projecting the workpiece on a two-dimensional plane perpendicular to the rotation axis and is defined together with a shape of the workpiece is obtained based on a plurality of measurement points on the workpiece that are decided as points required to specify the two-dimensional coordinate of the reference point, at at least two index angles while indexing the rotation axis by a predetermined angle, and a position of a rotation center line of the rotation axis is calculated based on a relationship between the index angles and a plurality of the two-dimensional coordinates of the reference point.

### Advantageous Effects of Invention

According to the present invention, in a numerical-control machine tool including a numerical control device that can correct influences of a position and a tilt of a rotation-axis center line and an installation position and a tilt of a workpiece, even when a position and a tilt of a rotation center vary according to a change in a mass or a temperature of a workpiece, a position and a tilt of a rotation center line can be accurately measured and also an installation position of the workpiece as a relative displacement from a rotation-axis center position can be accurately measured. As a result, accurate machining with correction can be performed. Furthermore, all errors can be measured with fewer measurement points than in a case where the position and the tilt of the rotation-axis center line and the installation position and the tilt of the workpiece are separately measured.

Furthermore, in a numerical-control machine tool including a numerical control device that can correct an influence of a position of a rotation-axis center line and influences of an installation position and a tilt of a workpiece, even when a rotation center position varies according to a change in a mass or a temperature of a workpiece, a position of a rotation center line can be accurately measured and an installation position of the workpiece as a relative displacement from a rotation-axis center position can be also accurately measured. As a result, accurate machining with correction can be performed.

Further, because a position and a tilt of a rotation center line of a rotation axis can be measured using a workpiece, measurement can be performed immediately before machining. As result, even when a position and a tilt of a rotation center varies according to a change in a mass or a temperature of the workpiece, the position and the tilt of the rotation center line can be accurately measured and thus accurate machining with correction can be performed.

### BRIEF DESCRIPTION OF DRAWINGS

FIG. 1 is a flowchart of operation procedures performed by an error measurement device according to a first embodiment of the present invention.

FIG. 2 is a flowchart of operation procedures performed by an error measurement device according to a second embodiment of the present invention.

FIG. 3 is a flowchart of process procedures performed at a rotation-axis geometric-deviation measuring step S2 of the process procedures shown in FIG. 1.

FIG. 4 is a flowchart of process procedures at a rotation-center-position measuring step S6 in the process procedures shown in FIG. 2.

FIG. 5 is a flowchart of process procedures for detecting a rough installation position of a workpiece and rotating a rotation axis.

FIG. 6 are explanatory diagrams of a relationship between an attitude of a rotation axis and a reference position on a workpiece for measuring a position and a tilt of a rotation center line.

FIG. 7 are explanatory diagrams of a measurement route when a position and a tilt of a rotation center line are measured.

FIG. 8 are explanatory diagrams of a method of measuring a rotation center position of a C-axis.

FIG. 9 are explanatory diagrams of a measurement route when the rotation center position of the C-axis is measured.

FIG. 10 are explanatory diagrams of a method of measuring a rotation center position of an A-axis.

FIG. 11 are explanatory diagrams of a measurement route when the rotation center position of the A-axis is measured.

FIG. 12 are explanatory diagram of a position and a tilt of an installation position of a workpiece to be measured in the present invention.

FIG. 13 is a perspective view for explaining a measurement point for measuring a position in a lower left corner on an upper surface of a workpiece and a measurement route thereof.

FIG. 14 is a perspective view for explaining a measurement point for measuring a position in an upper left corner on an upper surface of a workpiece and a measurement route thereof.

### DESCRIPTION OF EMBODIMENTS

Exemplary embodiments of the present invention will be explained with a multi-axis machine tool having an A-axis (a tilt axis) and a C-axis (a rotation axis) on the side of a work table as an example. The present invention can be also applied to a multi-axis machine tool having an axis configuration other than that described in the embodiments with effects identical to those of the following embodiments.

### First Embodiment

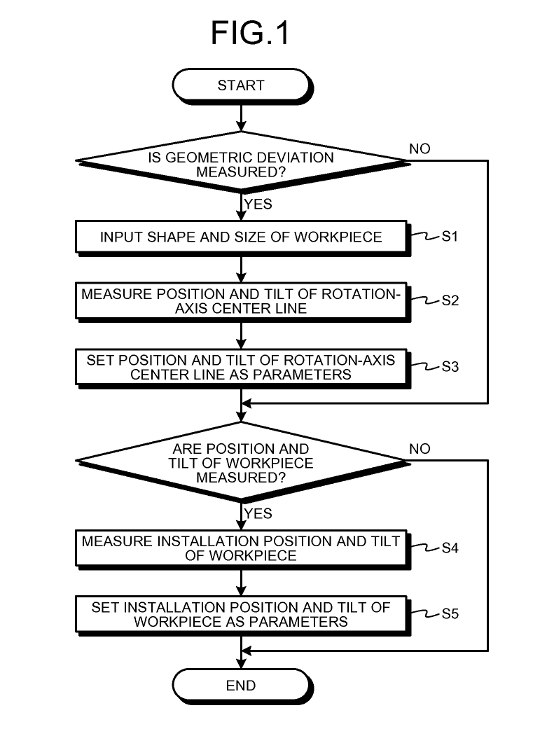

A first embodiment of the present invention is explained with reference to FIG. 1. FIG. 1 is a flowchart of operation procedures performed by an error measurement device according to the first embodiment. The error measurement device includes an operation program in which the procedures shown in FIG. 1 are described and a central processing unit (CPU) that causes the device to execute the operation program, and the error measurement device operates according to the procedures shown in FIG. 1. Parts in which the procedures of the operation program are described and the CPU that causes the device to execute the operation program constitute units that perform operation procedures. The error measurement device according to the present embodiment has a workpiece setting step (workpiece setting unit) S1, a rotation-axis geometric-deviation measuring step (rotation-axis geometric-deviation measurement unit) S2, a geometric-deviation-parameter setting step (geometric-deviation-parameter setting unit) S3, a workpiece-installation-error measuring step (workpiece-installation-error measurement unit) S4, and a workpiece-installation-error parameter setting step (workpiece-installation-error parameter setting unit) S5.

The error measurement device according to the present embodiment first sets the size and shape of a workpiece that is fixed at a predetermined position on the work table at the workpiece setting step S1. To set the size and shape, the size and shape can be input, for example, as three-dimensional computer-aided design (CAD) or two-dimensional CAD data. Alternatively, it is possible to select an appropriate one of previously-provided shape patterns and to input the size thereof.

At the rotation-axis geometric-deviation measuring step S2, a position and a tilt of a rotation-axis center line are measured based on the size and shape of the workpiece set at the workpiece setting step S1, information indicating the size of the work table to which the workpiece is fixed, machine information set in a numerical control device, such as an axis configuration type of a machine tool and a movable range of each axis, and information related to a measurement device that can measure a coordinate of an arbitrary point on the workpiece. In this case, a geometric error such as the position or the tilt of the rotation-axis center line is referred to as “rotation-axis geometric deviation”. The rotation-axis geometric deviation is explained in detail, for example, in Non Patent Literature 2 mentioned above.

A device referred to as “touch probe” is generally known as a measurement device that can measure a coordinate of an arbitrary point on the workpiece. Information related to the measurement device in this case includes a diameter of a tip contact point of the touch probe, a stylus length, and a tool length. However, the measurement method in the present embodiment is not limited to that using the touch probe and identical effects are expected with a measurement method using a device other than the touch probe, for example, a laser displacement meter or an image sensor.

The rotation-axis geometric deviation measured at the rotation-axis geometric-deviation measuring step S2 in FIG. 1 is set in the numerical control device at the geometric-deviation-parameter setting step S3. The geometric-deviation-parameter setting step S3 can be performed, for example, in a mode in which a parameter of a geometric deviation displayed on a screen is input by an operator or a mode in which a measured value is directly reflected on a parameter of the numerical control device.

At the workpiece-installation-error measuring step S4, an installation position and a tilt of the workpiece fixed at the predetermined position are measured. The installation position is calculated as a relative position to the rotation-axis center position measured at the rotation-axis geometric-deviation measuring step S2. At the workpiece-installation-error parameter setting step S5, the installation position and the tilt of the workpiece measured at the workpiece-installation-error measuring step S4 are set in the numerical control device. The workpiece-installation-error parameter setting step S5 can be performed, for example, in a mode in which a value displayed on a screen is input by an operator or a mode in which a measured value is directly reflected on a parameter of the numerical control device. In this case, the installation position of the workpiece with reference to the rotation center position and the tilt of the workpiece are referred to as “workpiece installation errors”.

A detailed method of measuring a geometric deviation of a rotation axis at the rotation-axis geometric-deviation measuring step S2 is explained below with a specific example in which a geometric deviation is measured using a touch probe when a cuboid workpiece is fixed on a work table.

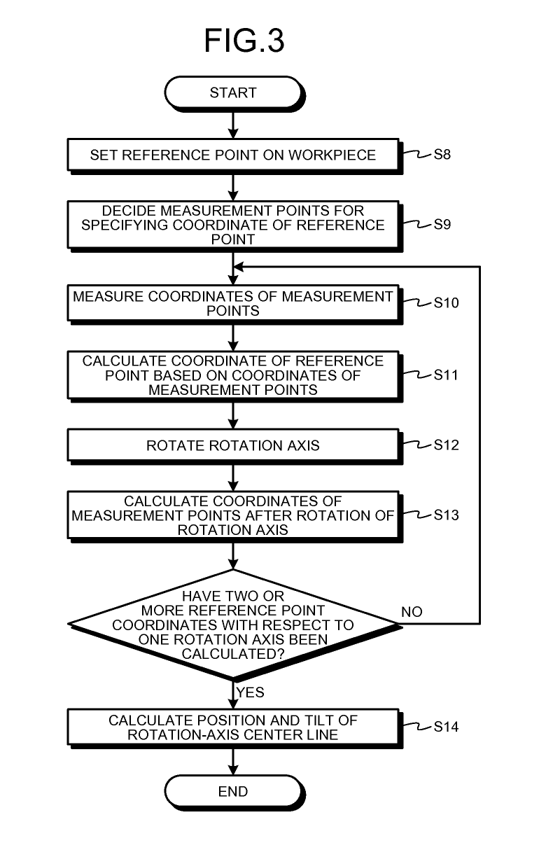

FIG. 3 is a flowchart of process procedures performed at the rotation-axis geometric-deviation measuring step S2 of the process procedures shown in FIG. 1. The rotation-axis geometric-deviation measuring step S2 includes an operation program in which the procedures shown in FIG. 3 are described and a CPU that causes the device to execute the operation program, and the rotation-axis geometric-deviation measuring step S2 is performed according to the procedures shown in FIG. 3. Parts in which the procedures of the operation program are described and the CPU that causes the device to execute the operation program constitute units that perform operations of the procedures. The error measurement device according to the present embodiment has a reference-point setting step (reference-point setting unit) S8, a measurement-point deciding step (measurement-point decision unit) S9, a coordinate measuring step (coordinate measurement unit) S10, a reference-point-coordinate calculating step (reference-point-coordinate calculation unit) S11, a rotation-axis rotating step (rotation-axis rotation unit) S12, a post-rotation measurement-point calculating step (post-rotation measurement-point calculation unit) S13, and a rotation-axis geometric-deviation calculating step (rotation-axis geometric-deviation calculation unit) S14, as the rotation-axis geometric-deviation measuring step (rotation-axis geometric-deviation measurement unit) S2.

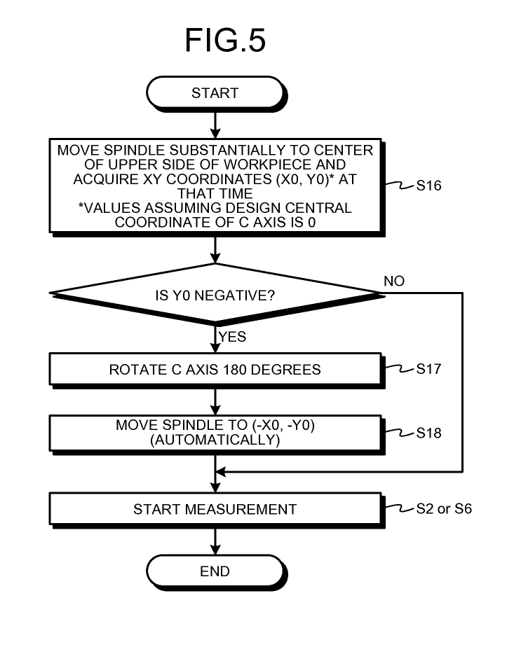

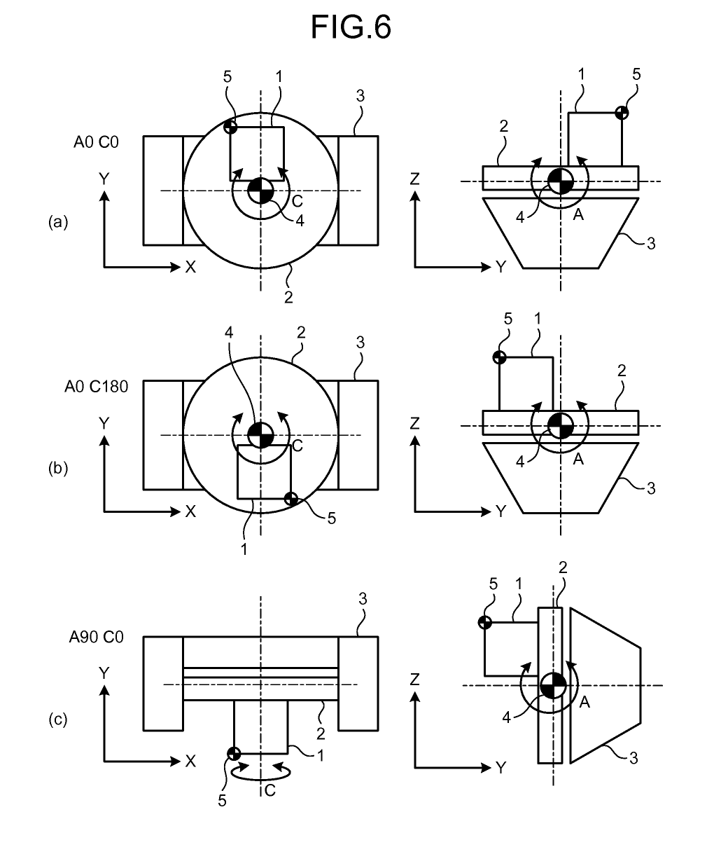

First, at the reference-point setting step S8, a point on the workpiece is set as a reference point based on the information set at the workpiece setting step S1. FIG. 6 are explanatory diagrams of a relationship between an attitude of a rotation axis and a reference position on a workpiece for measuring a position and a tilt of a rotation center line. A work table unit 2 on which a workpiece 1 is mounted at a predetermined position rotates on a tilt axis unit 3 around a central axis (C-axis) of the tilt axis unit 3. FIG. 6(a) depicts a case where the A-axis is at 0 degree and the C-axis is at 0 degree, FIG. 6(b) depicts a case where the A-axis is at 0 degree and the C-axis is at 180 degrees, and FIG. 6(c) depicts a case where the A-axis is at 90 degrees and the C-axis is at 0 degree. In FIG. 6, a reference point 5 for measuring a geometric deviation between the A-axis and the C-axis, and positions of the reference point 5 resulting from rotation of the rotation axis are schematically shown. When the workpiece is a cuboid, the reference point 5 is set at a corner as distant from a rotation center 4 as possible. This is to specify a coordinate of the reference point more accurately with fewer measurement points than in a case where the reference point 5 is set at the center of the cuboid, for example.

However, the present embodiment is not limited thereto when a measurement device other than the touch probe is used, and a suitable reference point for characteristics of a sensor to be used can be set. Also when the workpiece is in a shape other than a cuboid, it suffices to select a suitable reference point for the shape. For example, when the workpiece is cylindrically-shaped, it is preferable to select the center of an end face of the cylinder, and when the workpiece is a sphere, it is preferable to select the sphere center.

Generally, in a machine having the A-axis serving as a tilt axis and the C-axis serving as a rotation axis, the movable range of the A-axis is smaller than that of the C-axis that can rotate 360 degrees and is unsymmetrically limited, for example, to a range from −30 degrees to 120 degrees assuming that the direction of a right-hand thread is positive. When the workpiece 1 is installed as shown in FIG. 6, the coordinate of the reference point 5 can be specified by the touch probe even in a state where the A-axis is rotated 90 degrees. However, for example, if the workpiece is installed on the −Y side of the A-axis center line, measurement by the touch probe cannot be performed in a state where the A-axis is rotated 90 degrees.

To solve this problem, the error measurement device according to the present invention has a unit that detects a rough installation position of the workpiece, a unit that calculates a measurement point on the workpiece necessary to specify a position of the reference point when the rotation axis is rotated a predetermined angle, and a unit that determines whether the measurement point can be measured by a position measurement function included in a numerical-control machine tool, and when it is determined that the measurement cannot be performed, changes the reference point, changes the predetermined angle of the rotation axis, rotates a rotation axis to which the workpiece is fixed, or changes a fixation position of the workpiece.

A specific example for the multi-axis machine tool described in the present embodiment is explained with reference to FIG. 5. FIG. 5 is a flowchart of process procedures for detecting a rough installation position of the workpiece and rotating the rotation axis. As shown in FIG. 5, the error measurement device includes a workpiece approximate-center-position acquiring step (workpiece approximate-center-position acquisition unit) S16, a work-table rotating step (work-table rotation unit) S17, and a workpiece following step (workpiece following unit) S18.

First, at the workpiece approximate-center-position acquiring step S16, a spindle is moved to a rough center position on the workpiece, for example, with a manual pulse handle, and coordinate values at that time are acquired. In the case of the multi-axis machine tool described in the present embodiment, measurement cannot be performed when the workpiece is located on the −Y side of the A-axis center line and thus, when the sign of a Y-coordinate acquired at the workpiece approximate-center-position acquiring step S16 is negative, the C-axis is rotated 180 degrees to change the position of the workpiece. In this way, the workpiece is moved to the +Y side and therefore the coordinate of the reference point 5 can be specified even in a state where the A-axis is rotated 90 degrees.

The process shown in FIG. 5 is a specific example in the present embodiment, and the present invention is not limited to the process shown in FIG. 5. For example, the workpiece approximate-center-position acquiring step can be achieved by an image sensor or the like, or the installation position of the workpiece can be changed instead of performing the work-table rotating step S17.

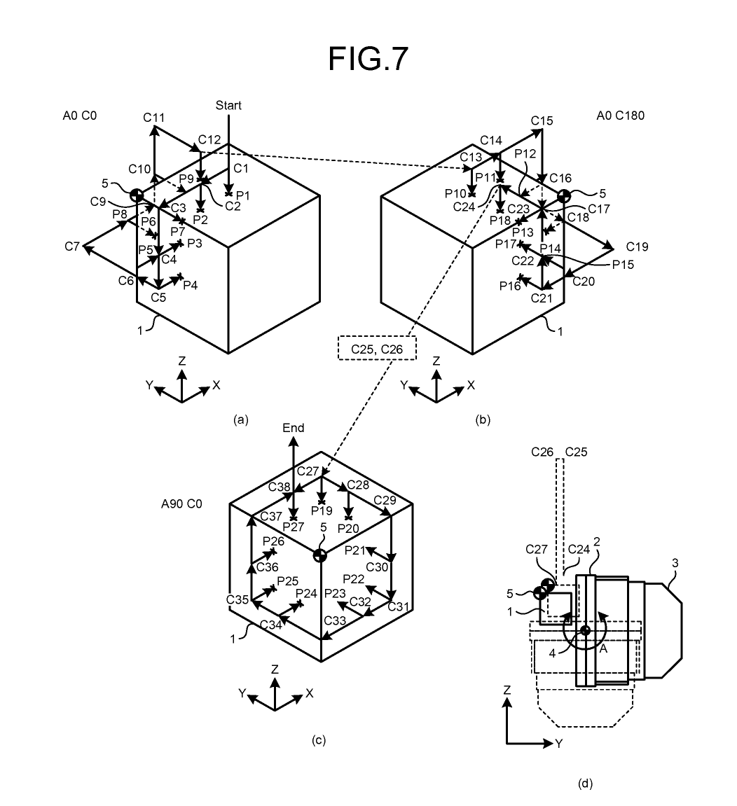

At the measurement-point deciding step S9, measurement points required to specify the coordinate of the reference point 5 set at the reference-point setting step S8 are decided. FIGS. 7(a), 7(b), and 7(c) are perspective views of positions of measurement points on the workpiece 1 and a measurement route (measurement order) thereof, and FIG. 7(d) depicts how the work table unit 2 having the workpiece 1 mounted thereon rotates around the A-axis.

FIG. 7 depict measurement points decided at the measurement-point deciding step S9 and a measurement route thereof. Each measurement point coordinate Pn=(Pnx, Pny, Pnz) and each corner coordinate Cn=(Cnx, Cny, Cnz) are calculated as follows. In this case, n is a measurement point or corner number. The workpiece following step S18 in the process shown in FIG. 5 is started or movement is started from a measurement start point set substantially at the center over the workpiece and is shifted in the −Z direction to measure a coordinate of a first measurement point, and then corners and measurement points are passed in a numerical order. Coordinates of the measurement points and the corners are coordinate values with reference to a design rotation-center coordinate.

At the coordinate measuring step S10, a three-dimensional coordinate value of each of the measurement points is acquired and then coordinates of the next corner and the next measurement point are sequentially decided based on the acquired coordinate value. When measurement of nine points is completed with respect to one rotation axis attitude (index angle), the rotation axis is rotated at the rotation-axis rotating step S12, and coordinates of the measurement points after rotation of the rotation axis are sequentially calculated at the post-rotation measurement-point calculating step S13, thereby measuring the coordinates of the measurement points.

In this case, W is a width (X direction) of the workpiece, D is a depth (Y direction) of the workpiece, H is a height (Z direction) of the workpiece, Zo is a Z-axis machine origin, Ls is a stylus length of the touch probe, and Do is an offset distance from a workpiece surface at the time of movement. The following coordinate calculation formulae are examples in a case where measurement is performed with the A-axis being rotated 90 degrees.

C1=(P1x, P1y, P1z+Do)

C2=(P1x−W/4, P1y, P1z+Do)

C3=(P2x−W/4−Do, P2y, P2z+Do)

if Ls>H

C4=(P2x−W/4−Do, P2y, P2z−(H−Do)/2)

else

C4=(P2x−W/4−Do, P2y, P2z−(Ls−Do)/2)

end

C5=(P3x−Do, P3y, 2P3z−P2z)

C6=(P4x−Do, P4y+D/4, P4z)

C7=(P5x−Do, P5y+D/4+Do, P5z)

C8=(P5x+W/4, P5y+D/4+Do, P5z)

C9=(P6x+W/4, P6y+Do, P6z)

C10=(P7x, P7y+Do, P3z)

C11=(P8x, P8y+Do, P1z+Do)

C12=(P1x, P1y+D/4, P1z+Do)

C13=(−P1x, −P1y, P1z+Do)

C14=(P10x+W/4, P10y, P10z+Do)

C15=(P11x+W/4+Do, P11y, P11z+Do)

if Ls>H

C16=(P11x+W/4+Do, P11y, P11z−(H−Do)/2)

else

C16=(P11x+W/4+Do, P11y, P11z−(Ls−Do)/2)

end

C17=(P12x+Do, P12y, 2P12z−P11z)

C18=(P13x+Do, P13y−D/4, P13z)

C19=(P14x+Do, P14y−D/4−Do, P14z)

C20=(P14x−D/4, P14y−D/4−Do, P14z)

C21=(P15x−W/4, P15y−Do, P15z)

C22=(P16x, P16y−Do, P12z)

C23=(P17x, P17y−Do, P10z+Do)

C24=(P10x, P10y−D/4, P10z+Do)

C25=(P18x, P18y, Zo)

C26=(P7x, −P7z, Zo)

C27=(P7x, −P7z, P7y+Do)

C28=(P19x, −P8z, P19z+Do)

C29=(P20x, −P9z−Do, P19z+Do)

C30=(P20x, −P9z−Do, P20z−(Ls−Do)/2)

C31=(P21x, P21y−Do, 2P21z−P20z)

C32=(P22x−W/4, P22y−Do, P22z)

C33=(P23x−W/4−Do, P23y−Do, P23z)

C34=(P23x−W/4−Do, P20y, P23z)

C35=(P24x−Do, P19y, P24z)

C36=(P25x−Do, P25y, P21z)

C37=(P26x−Do, P26y, P19z+Do)

C38=(P19x−W/4, P19y, P19z+Do)

In the present embodiment, coordinates of nine points including three points on each of the planes with respect to one rotation axis attitude and for three rotation axis attitudes, that is, a total of 27 points are measured. However, assuming that the planes of the workpiece are perpendicular to each other, all reference point coordinates can be obtained by measurement of a minimum of six points with respect to one rotation axis attitude, that is, a total of 18 points.

At the reference-point-coordinate calculating step S11, an equation of a plane is obtained from measurement results of three points on the same plane, and a coordinate of an intersection of three planes is calculated from three equations of a plane as a reference point coordinate. Calculation of an equation of a plane and of an intersection of planes can be achieved by a widely known method. The method is also explained in detail in explanations of the workpiece-installation-error measuring step S4 and can be applied as it is. At the rotation-axis geometric-deviation calculating step S14, a position and a tilt of the rotation-axis center line are calculated using reference point coordinates at two angles with respect to one rotation axis.

When a reference point coordinate in a case where the A-axis is at 0 degree and the C-axis is at 0 degree is P_{A0C0} and a reference point coordinate in a case where the A-axis is at 0 degree and the C-axis is at 180 degrees is P_{AOC180}, a position P_{c} and a tilt θ_{c} of the C-axis rotation center line are represented by expressions 1 and 2, respectively. The rotation center position P_{c} in this case is a center position at a height z_{c}.

$$\begin{matrix}\begin{matrix}{P}_{C} = ( \begin{matrix}{x}_{c} & {y}_{c} & {z}_{c}\end{matrix} ) \\ = ( \begin{matrix}\frac{( {x}_{A 0 C 0} + {x}_{A 0 C 180} )}{2} & \frac{( {y}_{A 0 C 0} + {y}_{A 0 C 180} )}{2} & \frac{( {z}_{A 0 C 0} + {z}_{A 0 C 180} )}{2}\end{matrix} )\end{matrix} & ( 1 ) \\ \begin{matrix}{θ}_{C} = ( \begin{matrix}{α}_{c} & {β}_{c} & {γ}_{c}\end{matrix} ) \\ = ( \begin{matrix}{Tan}^{- 1} ( \frac{{z}_{A 0 C 180} - {z}_{A 0 C 0}}{{y}_{A 0 C 180} - {y}_{A 0 C 0}} ) & {Tan}^{- 1} ( \frac{{z}_{A 0 C 180} - {z}_{A 0 C 0}}{{x}_{A 0 C 180} - {x}_{A 0 C 0}} ) & 0\end{matrix} )\end{matrix} & ( 2 )\end{matrix}$$

When a C-axis vector [0 0 1]^{T} is rotated around each axis using a result of the expression 2, a C-axis vector C is represented by the following expression 3.

$$C = [ \begin{matrix}{c}_{i} \\ {c}_{j} \\ {c}_{k}\end{matrix} ] = [ \begin{matrix}cos {β}_{c} & sin {β}_{c} sin {α}_{c} & sin {β}_{c} cos {α}_{c} \\ 0 & cos {α}_{c} & - sin {α}_{c} \\ - sin {β}_{c} & cos {β}_{c} sin {α}_{c} & cos {β}_{c} cos {α}_{c}\end{matrix} ] [ \begin{matrix}0 \\ 0 \\ 1\end{matrix} ] = [ \begin{matrix}sin {β}_{c} cos {α}_{c} \\ - sin {α}_{c} \\ cos {β}_{c} cos {α}_{c}\end{matrix} ] \qquad ( 3 )$$

Therefore, an expression 4 is obtained as an equation of a line representing the rotation center line of the C-axis.

$$\frac{x - {x}_{c}}{{c}_{i}} = \frac{y - {y}_{c}}{{c}_{j}} = \frac{z - {z}_{c}}{{c}_{k}} \qquad ( 4 )$$

Furthermore, when a reference point coordinate in a case where the A-axis is at 90 degrees and the C-axis is at 0 degree is P_{A90C0}, a position P_{A} and a tilt θ_{A} of the C-axis rotation center line are represented by expressions 5 and 6, respectively.

$$\begin{matrix}\begin{matrix}{P}_{A} = ( \begin{matrix}{x}_{a} & {y}_{a} & {z}_{a}\end{matrix} ) \\ = ( \frac{( {x}_{A 0 C 0} - {x}_{A 90 C 0} )}{( {y}_{A 0 C 0} - {y}_{A 90 C 0} )} \cdot ( {Y}_{A 0 C 0} - {y}_{a} ) {y}_{a} {z}_{a} )\end{matrix} & ( 5 ) \\ \begin{matrix}{θ}_{A} = ( \begin{matrix}{α}_{a} & {β}_{a} & {γ}_{a}\end{matrix} ) \\ = ( \begin{matrix}0 & - {Tan}^{- 1} ( \frac{{x}_{A 90 C 0} - {x}_{A 0 C 0}}{{z}_{A 90 C 0} - {z}_{A 0 C 0}} ) & - {Tan}^{- 1} ( \frac{{x}_{A 90 C 0} - {x}_{A 0 C 0}}{{y}_{A 90 C 0} - {y}_{A 0 C 0}} )\end{matrix} )\end{matrix} & ( 6 )\end{matrix}$$

A y direction position yₐ and a z direction position zₐ of the A-axis center line are calculated as an intersection between a line segment obtained by rotating a line segment connecting the reference point P_{AOC0} and the reference point P_{A90C0} 45 degrees around the reference point P_{A0C0}, and a line segment obtained by rotating the line segment connecting the reference point P_{A0C0} and the reference point P_{A90C0} −45 degrees around the reference point P_{A90C0}.

When an A-axis vector [1 0 0]^{T} is rotated around each axis using a result of the expression 6, the A-axis vector is represented by the following expression 7.

$$A = [ \begin{matrix}{a}_{i} \\ {a}_{j} \\ {a}_{k}\end{matrix} ] = [ \begin{matrix}cos {γ}_{a} cos {β}_{a} & - sin {γ}_{a} & cos {γ}_{a} sin {β}_{a} \\ sin {γ}_{a} cos {β}_{a} & cos {γ}_{a} & sin {γ}_{a} sin {β}_{a} \\ - sin {β}_{a} & 0 & cos {β}_{a}\end{matrix} ] [ \begin{matrix}1 \\ 0 \\ 0\end{matrix} ] = [ \begin{matrix}cos {γ}_{a} cos {β}_{a} \\ sin {γ}_{a} cos {β}_{a} \\ - sin {β}_{a}\end{matrix} ] \qquad ( 7 )$$

Therefore, an expression 8 is obtained as an equation of a line representing the rotation center line of the A-axis.

$$\frac{x - {x}_{a}}{{a}_{i}} = \frac{y - {y}_{a}}{{a}_{j}} = \frac{z - {z}_{a}}{{a}_{k}} \qquad ( 8 )$$

An intersection between a plane containing the A-axis center line and the Y-axis and the C-axis center line is then calculated. A normal vector of the plane containing the A-axis center line and the Y-axis is a cross product of the A-axis vector (the expression 7) and a Y-axis vector [0 1 0]^{T} and thus can be calculated as follows.

$$\begin{matrix}A \times Y = ( \begin{matrix}0 \cdot {a}_{j} - 1 \cdot {a}_{k} & 0 \cdot {a}_{k} - 0 \cdot {a}_{i} & 1 \cdot {a}_{i} - 0 \cdot {a}_{j}\end{matrix} ) \\ = ( \begin{matrix}- {a}_{k} & 0 & {a}_{i}\end{matrix} )\end{matrix} \qquad ( 9 )$$

Therefore, an equation of the plane containing the A-axis center line and the Y-axis becomes an expression 10.

−a_{z}(x−xₐ)+aₓ(z−zₐ)=0 (10)

An intersection between the plane represented by the expression 10 and the rotation center line of the C-axis is the C-axis rotation center position P_{c} at the height of the A-axis rotation center. The intersection between the plane containing the A-axis center line and the Y-axis and the C-axis rotation center line is obtained as follows according to the expressions 4 and 10.

$${P}_{c} = ( \begin{matrix}\frac{{a}_{k} ( {x}_{c} - {x}_{a} ) + {a}_{i} ( {z}_{a} - {z}_{c} )}{{a}_{i} {c}_{k} - {a}_{k} {c}_{i}} \cdot {c}_{i} + {x}_{c} \\ \frac{{a}_{k} ( {x}_{c} - {x}_{a} ) + {a}_{i} ( {z}_{a} - {z}_{c} )}{{a}_{i} {c}_{k} - {a}_{k} {c}_{i}} \cdot {c}_{j} + {y}_{c} \\ \frac{{a}_{k} ( {x}_{c} - {x}_{a} ) + {a}_{i} ( {z}_{a} - {z}_{c} )}{{a}_{i} {c}_{k} - {a}_{k} {c}_{i}} \cdot {c}_{k} + {z}_{c}\end{matrix} ) \qquad ( 11 )$$

An intersection between a plane containing the C-axis center line and the Y-axis and the A-axis center line is then calculated. A normal vector of the plane containing the C-axis center line and the Y-axis is a cross product of the C-axis vector (the expression 3) and the Y-axis vector [0 1 0]^{T} and thus can be calculated as follows.

$$\begin{matrix}C \times Y = ( \begin{matrix}0 \cdot {c}_{j} - 1 \cdot {c}_{k} & 0 \cdot {c}_{k} - 1 \cdot {c}_{i} & 1 \cdot {c}_{i} - 0 \cdot {c}_{j}\end{matrix} ) \\ = ( \begin{matrix}- {c}_{k} & 0 & {c}_{i}\end{matrix} )\end{matrix} \qquad ( 12 )$$

Therefore, an equation of the plane containing the C-axis center line and the Y-axis becomes an expression 13.

−c_{z}(x−x_{c})+cₓ(z−z_{c})=0 (13)

An intersection between the plane represented by the expression 13 and the rotation center line of the A-axis is an A-axis rotation center position P_{A} at an X direction position of the C-axis rotation center. The intersection between the plane containing the C-axis center line and the Y-axis and the A-axis center line is obtained as follows according to the expressions 8 and 13.

$${P}_{A} = ( \begin{matrix}\frac{{c}_{k} ( {x}_{c} - {x}_{a} ) + {c}_{i} ( {z}_{a} - {z}_{c} )}{{a}_{i} {c}_{k} - {a}_{k} {c}_{i}} \cdot {a}_{i} + {x}_{a} \\ \frac{{c}_{k} ( {x}_{c} - {x}_{a} ) + {c}_{i} ( {z}_{a} - {z}_{c} )}{{a}_{i} {c}_{k} - {a}_{k} {c}_{i}} \cdot {a}_{j} + {y}_{a} \\ \frac{{c}_{k} ( {x}_{c} - {x}_{a} ) + {c}_{i} ( {z}_{a} - {z}_{c} )}{{a}_{i} {c}_{k} - {a}_{k} {c}_{i}} \cdot {a}_{k} + {z}_{a}\end{matrix} ) \qquad ( 14 )$$

From these results, eight geometric deviations included in the rotation axes of the multi-axis machine tool having the A-axis and the C-axis on the table side can be calculated according to an expression 15. In this expression, δ_{xAx} is an X direction deviation of the A-axis origin, δ_{yAx} is a Y direction deviation of the A-axis origin, δ_{zAx} is a Z direction deviation of the A-axis origin, δ_{yCA} is a Y direction offset between the A-axis center line position and the C-axis center line position, α_{AX} is an angular deviation between the C-axis center line and the Z-axis on a YZ plane, γ_{AX} is an angular deviation between the A-axis center line and the X-axis on an XZ plane, β_{AX} is an angular deviation between the A-axis center line and the X-axis on an XY plane, and β_{CA} is an angular deviation between the A-axis center line and the C-axis center line on the XZ plane.

$$\{ \begin{matrix}{δ}_{xAX} = \frac{{c}_{k} ( {x}_{c} - {x}_{a} ) + {c}_{i} ( {z}_{a} - {z}_{c} )}{{a}_{i} {c}_{k} - {a}_{k} {c}_{i}} \cdot {a}_{i} + {x}_{a} \\ {δ}_{yAX} = \frac{{c}_{k} ( {x}_{c} - {x}_{a} ) + {c}_{i} ( {z}_{a} - {z}_{c} )}{{a}_{i} {c}_{k} - {a}_{k} {c}_{i}} \cdot {a}_{j} + {y}_{a} \\ {δ}_{zAX} = \frac{{c}_{k} ( {x}_{c} - {x}_{a} ) + {c}_{i} ( {z}_{a} - {z}_{c} )}{{a}_{i} {c}_{k} - {a}_{k} {c}_{i}} \cdot {a}_{k} + {z}_{a} \\ {δ}_{yCX} = \frac{{a}_{k} ( {x}_{c} - {x}_{a} ) + {a}_{i} ( {z}_{a} - {z}_{c} )}{{a}_{i} {c}_{k} - {a}_{k} {c}_{i}} \cdot {c}_{k} + {y}_{c} - {δ}_{yAX} \\ {α}_{AX} = {α}_{c} \\ {β}_{AX} = {β}_{A} \\ {γ}_{AX} = {γ}_{A} \\ {β}_{CA} = {β}_{C} - {β}_{A}\end{matrix} \qquad ( 15 )$$

While the method of measuring geometric deviations in the multi-axis machine tool having the A-axis and the C-axis on the side of a workpiece using a touch probe when a cuboid workpiece is fixed on a work table has been explained above, the present embodiment can be adequately applied by persons skilled in the art to a multi-axis machine tool having a different axis configuration. Even when the workpiece fixed on the table is not a cuboid, the same method can be applied only by changing the method of measuring the reference point.

A process performed at the workpiece-installation-error measuring step S4 is explained in detail below with an example in which a workpiece is a cuboid. While the present embodiment is explained for a case where the workpiece is a cuboid, the present invention is not limited thereto and, also when the workpiece is in a cylindrical shape or other shapes, the present invention can be applied by executing a measurement method suitable for the shape.

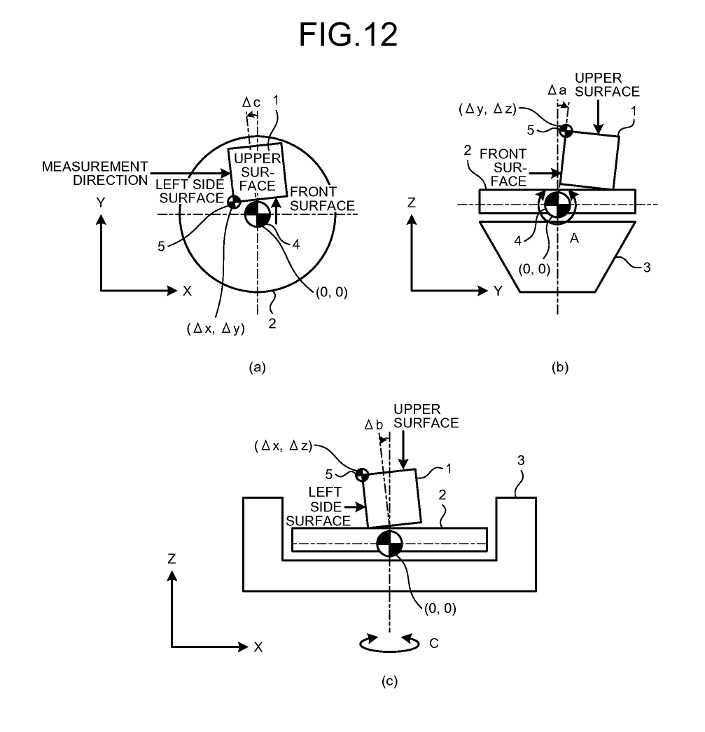

FIG. 12 are schematic diagrams for explaining workpiece installation errors in a case where the workpiece 1 in a cuboid shape is installed on the work table 2. FIG. 12(a) is a front view seen from the Z-axis direction, FIG. 12(b) is a side view seen from the X-axis direction, and FIG. 12(c) is a side view seen from the Y-axis direction. An installation position of the workpiece 1 in this case is defined as a displacement (Δx, Δy, Δz) of the reference point 5 from the rotation center 4 of the work table. A tilt of the workpiece 1 is defined as rotation angles (Δa, Δb, Δc) around the X-, Y-, and Z-axes, respectively.

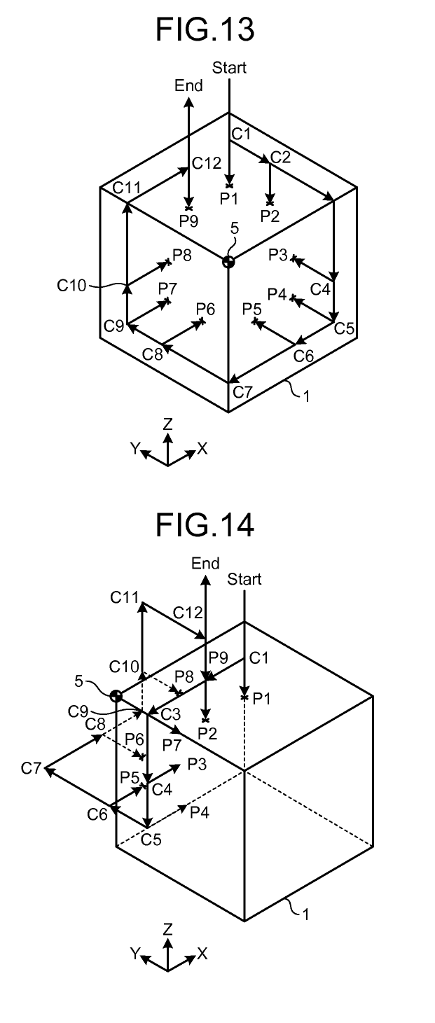

Measurement points and a measurement route thereof in a case where the reference point 5 is a lower left corner on an XY plane are shown in FIG. 13. Each measurement point coordinate Pn=(Pnx, Pny, Pnz) and each corner coordinate Cn=(Cnx, Cny, Cnz) are calculated as follows. In this case, n is a measurement point or corner number. Measurement is started from a measurement start point set substantially at the center over the workpiece and is shifted in the −Z direction. After a coordinate of a first measurement point is measured, corners and measurement points are passed in a numerical order. Coordinates of the measurement points and the corners are coordinate values with reference to the rotation center coordinate measured at the rotation-axis geometric-deviation measuring step S2.

C1=(P1x, P1y, P1z+Do)

C2=(P1x, P1y−D/4, P1z+Do)

C3=(P2x, P2y−D/4−Do, P2z+Do)

if Ls>H

C4=(P2x, P2y−D/4−Do, P2z−(H−Do)/2)

else

C4=(P2x, P2y−D/4−Do, P2z−(Ls−Do)/2)

end

C5=(P3x, P3y−Do, 2P3z−P2z)

C6=(P4x−W/4, P4y−Do, P4z)

C7=(P5x−W/4−Do, P5y−Do, P5z)

C8=(P5x−W/4−Do, P5y+D/4, P5z)

C9=(P6x−Do, P6y+D/4, P6z)

C10=(P7x−Do, P1y, P3z)

C11=(P8x−Do, P8y, P1z+Do)

C12=(P1x−W/4, P1y, P1z+Do)

In this case, W is a width (X direction) of the workpiece, D is a depth (Y direction) of the workpiece, H is a height (Z direction) of the workpiece, Zo is a Z-axis machine origin, Ls is a stylus length of the touch probe, and Do is an offset distance from a workpiece surface at the time of movement.

Measurement points and a measurement route thereof in a case where the reference point 5 is an upper left corner on the XY plane are shown in FIG. 14. The measurement route in this case is the same as that for measuring a reference point when the A-axis and the C-axis are both at 0 degree at the rotation-axis geometric-deviation measuring step S2 and, in this case, the measurement operation is not performed again in the workpiece-installation-error measuring step S4.

While the coordinates of three points with respect to each of planes of the workpiece, that is, a total of nine points are measured in the measurement routes shown in FIGS. 13 and 14, the coordinate of the reference point can be specified with measurement of a total of six points assuming that the planes are perpendicular to each other. Also when the reference point is another point on the workpiece, such as an upper right corner, a lower right corner, or the center of an upper surface, measurement can be performed by creating a measurement route in the similar manner.

When the coordinates P₀, P₁, and P₂ of the three points measured with the touch probe are (x₀, Y₀, z₀), (x₁, Y₁, z₁), and (x₂, y₂, z₂), respectively, a normal vector n of the plane can be calculated according to expressions 16 and 17.

$$\begin{matrix}( {a}^{′} , {b}^{′} , {c}^{′} ) = {V}_{1} \times {V}_{2} = ( \begin{matrix}( {y}_{1} - {y}_{0} ) ( {z}_{2} - {z}_{0} ) - ( {z}_{1} - {z}_{0} ) ( {y}_{2} - {y}_{0} ) , \\ ( {z}_{1} - {z}_{0} ) ( {x}_{2} - {x}_{0} ) - ( {x}_{1} - {x}_{0} ) ( {z}_{2} - {z}_{0} ) , \\ ( {x}_{1} - {x}_{0} ) ( {y}_{2} - {y}_{0} ) - ( {y}_{1} - {y}_{0} ) ( {x}_{2} - {x}_{0} )\end{matrix} ) & ( 16 ) \\ n = ( a , b , c ) = ( \frac{{a}^{′}}{\sqrt{{a}^{′2} + {b}^{′2} + {c}^{′2}}} , \frac{{b}^{′}}{\sqrt{{a}^{′2} + {b}^{′2} + {c}^{′2}}} , \frac{{c}^{′}}{\sqrt{{a}^{′2} + {b}^{′2} + {c}^{′2}}} ) & ( 17 )\end{matrix}$$

The measured coordinates of the three points are offset by the radius of the contact point of the touch probe, using the normal vector n calculated according to the expression 17. A normal vector is calculated again based on offset coordinates of the three points according to the expressions 16 and 17 to obtain a general form of an equation of the plane.

ax+by+cz+d=0

where d=n·(−P₀)=n·(−P₁)=n·(−P₂) (18)

The calculation mentioned above is performed for each of the three planes and three equations of a plane are solved as simultaneous equations, thereby calculating a reference point coordinate (Δx, Δy, Δz) as an intersection according to an expression 19.

$$[ \begin{matrix}Δ x \\ Δ y \\ Δ z\end{matrix} ] = {[ \begin{matrix}{a}_{1} & {b}_{1} & {c}_{1} \\ {a}_{2} & {b}_{2} & {c}_{2} \\ {a}_{3} & {b}_{3} & {c}_{3}\end{matrix} ]}^{- 1} [ \begin{matrix}- {d}_{1} \\ - {d}_{2} \\ - {d}_{3}\end{matrix} ] \qquad ( 19 )$$

The tilt (Δa, Δb, Δc) of the workpiece corresponds to a roll angle, a pitch angle, and a yaw angle, respectively, and a coordinate rotation matrix thereof is calculated according to an expression 20.

$${R}_{F} = {R}_{Z} {R}_{Y} {R}_{X} = [ \begin{matrix}cos Δ c cos Δ b & cos Δ c sin Δ b sin Δ a - sin Δ c cos Δ a & cos Δ c sin Δ b cos Δ a + sin Δ c sin Δ a \\ sin Δ c cos Δ b & sin Δ c sin Δ b sin Δ a + cos Δ c cos Δ a & sin Δ c sin Δ b cos Δ a - cos Δ c sin Δ a \\ - sin Δ b & cos Δ b sin Δ a & cos Δ b cos Δ a\end{matrix} ] \qquad ( 20 )$$

When a normal vector (the main component is in the X direction) of the left side surface of the workpiece in a cuboid shape is n₁=(a₁, b₁, c₁), a normal vector (the main component is in the Y direction) of the front surface is n₂=(a₂, b₂, c₂), and a normal vector (the main component is in the Z direction) of the upper surface is n₃=(a₃, b₃, c₃), a coordinate transformation matrix representing the tilt of the workpiece is represented also by an expression 21.

$${R}_{F} = [ \begin{matrix}{n}_{1} & {n}_{2} & {n}_{3}\end{matrix} ] = [ \begin{matrix}{a}_{1} & {a}_{1} & {a}_{3} \\ {b}_{1} & {b}_{2} & {b}_{3} \\ {c}_{1} & {c}_{2} & {c}_{3}\end{matrix} ] \qquad ( 21 )$$

Therefore, when the expressions 20 and 21 are equated, the following expression 22 can be derived and the tilt (Δa, Δb, Δc) of the workpiece can be calculated.

$$Δ a = {tan}^{- 1} ( \frac{{c}_{2}}{{c}_{3}} ) , Δ b = {sin}^{- 1} ( - {c}_{1} ) , Δ c = {tan}^{- 1} ( \frac{{b}_{1}}{{a}_{1}} ) \\ ( - 90 ° < Δ a < 90 ° , - 90 ° < Δ c < 90 ° ) \qquad ( 22 )$$

However, the expressions 21 and 22 hold true in an ideal state where the planes of the cuboid are completely perpendicular to each other, and these cannot be applied as they are to a case where an actual workpiece is measured. Accordingly, one plane of the cuboid is then set as a main reference plane, another plane perpendicular to the main reference plane is set as a sub reference plane, and then normal vectors of the planes are calculated. There are five ways of selecting the main reference plane and three ways of selecting the sub reference plane corresponding thereto, that is, a total of 15 ways. Among these ways, a way of selecting the left side surface as the main reference plane and the front surface as the sub reference plane is explained in the present embodiment.

First, a cross product of the normal vector n₁ of the left side surface as the main reference plane and the normal vector n₂ of the front surface as the sub reference plane is calculated to set the calculated cross product as the normal vector n₃ of the upper surface. A cross product of the obtained normal vector n₃ of the upper surface and the normal vector n₁ of the left side surface is calculated to replace the normal vector n₂ of the front surface with the calculated cross product. All the normal vectors are normalized, a coordinate transformation matrix representing the tilt of the workpiece is calculated according to the expression 21, and the tilt (Δa, Δb, Δc) of the workpiece is calculated according to the expression 22. By the method mentioned above, the tilt of the workpiece can be appropriately calculated even when the planes are not perpendicular to each other in an actual workpiece.

It is readily possible for persons skilled in the art to calculate a tilt of a workpiece by reference to the method mentioned above even when different main reference plane and sub reference plane are selected.

### Second Embodiment

In a second embodiment of the present invention, a method of measuring a position of a rotation-axis center line, and an installation position and a tilt of a workpiece in a numerical-control machine tool having a translation axis and a rotation axis and including a numerical control device that can correct an influence of a position of a rotation-axis center line and influences of an installation position and a tilt of a workpiece is explained.

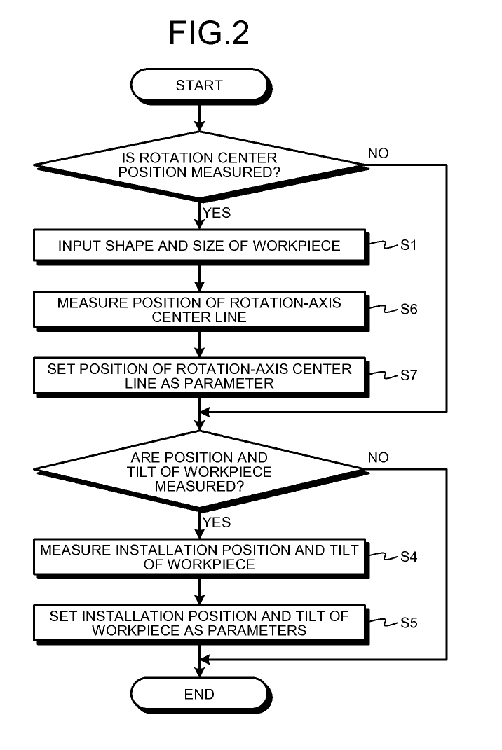

FIG. 2 is a flowchart of operation procedures performed by an error measurement device according to the second embodiment. The error measurement device includes an operation program in which the procedures shown in FIG. 2 are described and a CPU that causes the device to execute the operation program, and the error measurement device operates according to the procedures shown in FIG. 2. Parts in which the procedures of the operation program are described and the CPU that causes the device to execute the operation program constitute units that perform operation procedures. The error measurement device according to the present embodiment has a rotation-center-position measuring step (rotation-center-position measurement unit) S6 and a rotation-center-parameter setting step (rotation-center-parameter setting unit) S7, instead of the rotation-axis geometric-deviation measuring step (rotation-axis geometric-deviation measurement unit) S2 and the geometric-deviation-parameter setting step (geometric-deviation-parameter setting unit) S3 in the first embodiment.

In the present embodiment, first, the size and shape of a workpiece fixed at a predetermined position are set at the workpiece setting step S1. To set the size and shape, the size and shape can be input as three-dimensional CAD or two-dimensional CAD data, for example. Alternatively, it is possible to select an appropriate one of previously-provided shape patterns and to input the size thereof.

At the rotation-center-position measuring step S6, a position of the rotation-axis center line is measured based on the size and shape of the workpiece set at the workpiece setting step S1, information indicating the size of a work table to which the workpiece is fixed, machine information set in the numerical control device, such as an axis configuration type of a machine tool and a movable range of each axis, and information related to a measurement device that can measure a coordinate of an arbitrary point on the workpiece.

As a measurement device that can measure a coordinate of an arbitrary point on the workpiece, a device referred to as “touch probe” is generally used and information related to the measurement device in this case includes a diameter of a tip contact point of the touch probe, a stylus length, and a tool length. However, the measurement method in the present embodiment is not limited to that using the touch probe and identical effects are expected with a measurement method using a device other than the touch probe, for example, a laser displacement meter or an image sensor.

The rotation-axis center position measured at the rotation-center-position measuring step S6 is set in the numerical control device at the rotation-center-parameter setting step S7. The rotation-axis-center-parameter setting step S7 can be performed, for example, in a mode in which a parameter of a geometric deviation displayed on a screen is input by an operator or a mode in which a measured value is directly reflected on a parameter of the numerical control device.

At the workpiece-installation-error measuring step S4, an installation position and a tilt of the workpiece fixed at the predetermined position are measured. The installation position is calculated as a relative position to the rotation-axis center position measured at the rotation-center-position measuring step S6. At the workpiece-installation-error parameter setting step S5, the installation position and the tilt of the workpiece measured at the workpiece-installation-error measuring step S4 are set in the numerical control device. The workpiece-installation-error parameter setting step S5 can be performed, for example, in a mode in which a value displayed on a screen is input by an operator or a mode in which a measured value is directly reflected on a parameter of the numerical control device. In this case, the installation position of the workpiece with reference to the rotation center position and the tilt of the workpiece are referred to as “workpiece installation errors”.

A detailed method of measuring a center position of the rotation-axis center line at the rotation-center-position measuring step S6 is explained below with a specific example in which a geometric deviation is measured using a touch probe when a cuboid workpiece is fixed on a work table.

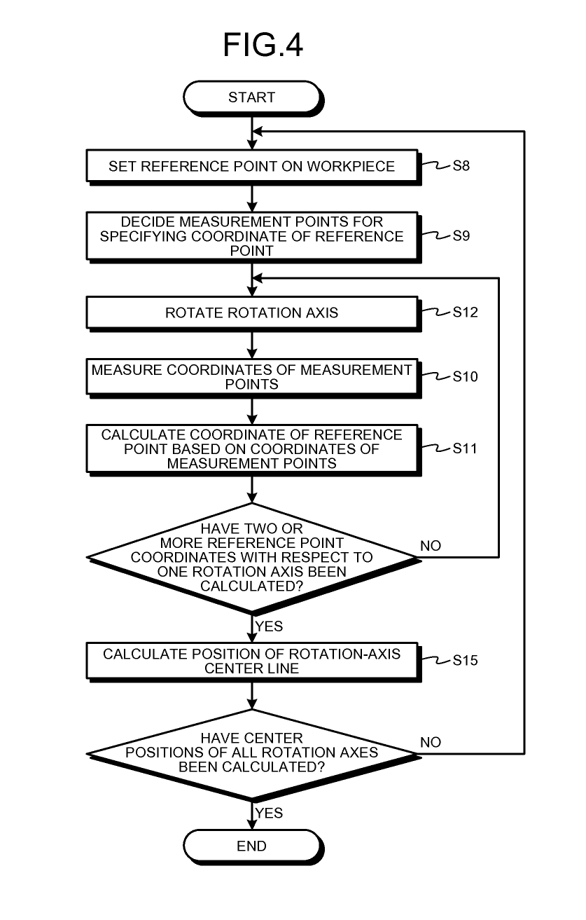

FIG. 4 is a flowchart of process procedures at the rotation-center-position measuring step S6 in the process procedures shown in FIG. 2. The error measurement device according to the present embodiment includes a rotation-center-position calculating step (rotation-center-position calculation unit) S15 instead of the rotation-axis geometric-deviation calculating step (rotation-axis geometric-deviation calculation unit) S14 in the first embodiment.

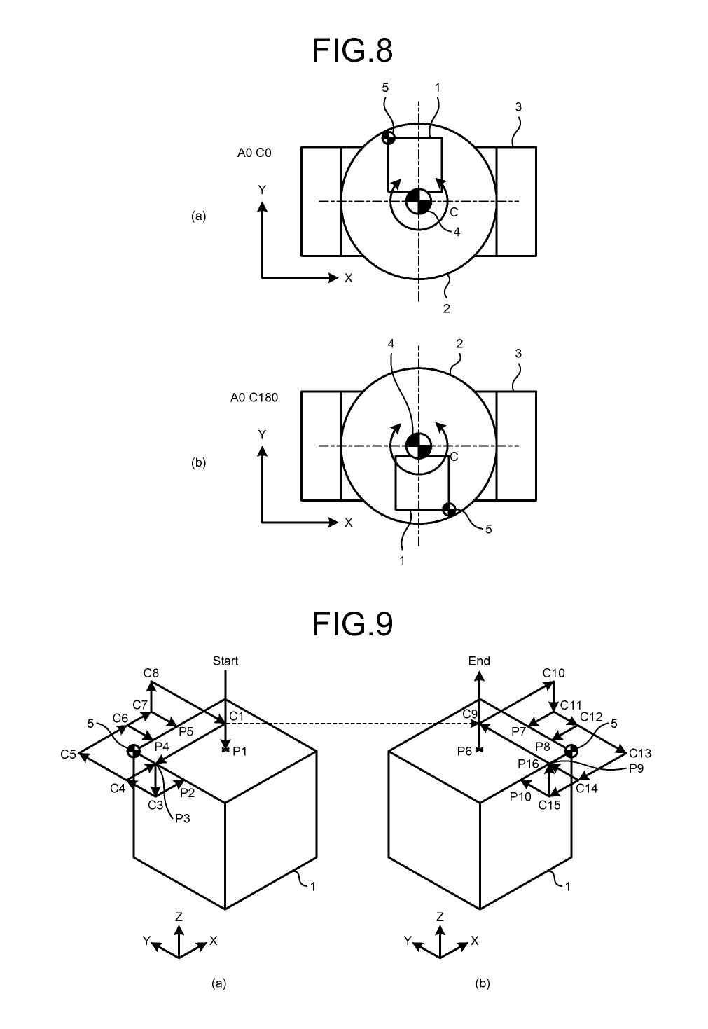

First, at the reference-point setting step S8, a point on the workpiece 1 in a state where the workpiece 1 is projected on a plane perpendicular to a rotation axis to be measured is set as a reference point based on the information set at the workpiece setting step S1. FIG. 8 schematically depict a reference point 5 for measuring a geometric deviation of the C-axis and a position of the reference point 5 resulting from rotation of the rotation axis. FIG. 8(a) depicts a case where the A-axis is at 0 degree and the C-axis is at 0 degree, and FIG. 8(b) depicts a case where the A-axis is at 0 degree and the C-axis is at 180 degrees. When the workpiece is a cuboid, the reference point 5 is set at a corner as distant from the rotation center 4 as possible. This is to specify the coordinate of the reference point more accurately with fewer measurement points, for example, than in a case where the reference point 5 is set at the center of the cuboid.

However, when a measurement device other than the touch probe is used, the reference point is not limited thereto and can be set at a suitable position for characteristics of a sensor to be used. Also when the workpiece is in a shape other than a cuboid, it suffices to select a reference point suitable for the shape. For example, it is preferable that the reference point is the center of a cylinder end face when the workpiece is in a cylindrical shape and is the sphere center when the workpiece is a sphere.

At the measurement-point deciding step S9, measurement points required to specify the coordinate of the reference point 5 set at the reference-point setting step S8 are decided. FIGS. 9(a) and 9(b) are perspective views of positions of measurement points on the workpiece 1 and a measurement route (measurement order) thereof. Each measurement point coordinate Pn=(Pnx, Pny, Pnz) and each corner coordinate Cn=(Cnx, Cny, Cnz) are calculated as follows. In this case, n is a measurement point or corner number. Measurement is started from a measurement start point set substantially at the center over the workpiece and shifted in the −Z direction. After the coordinate of the first measurement point is measured, the corners and the measurement points are passed in a numerical order. The coordinates of the measurement points and the corners are coordinate values with reference to a design coordinate of the rotation center.

At the coordinate measuring step S10, a three-dimensional coordinate value of each of the measurement points is acquired and then coordinates of the next corner and the next measurement point are sequentially decided based on the acquired coordinate value according to coordinate calculation formulae shown below. When measurement of four points with respect to one rotation axis attitude is completed, the rotation axis is rotated at the rotation-axis rotating step S12 and then the coordinates of the measurement points are measured again to calculate the coordinate of the reference point 5. In this case, W is a width (X direction) of the workpiece, D is a depth (Y direction) of the workpiece, H is a height (Z direction) of the workpiece, ds is a stylus diameter of the touch probe, Ls is a stylus length of the touch probe, and Do is an offset distance from a workpiece surface at the time of movement.

C1=(P1x, P1y, P1z+Do)

C2=(P1x−W/2−Do, P1y, P1z+Do)

C3=(P1x−W/2−Do, P1y, P1z−ds)

C4=(P2x−Do, P2y+D/4, P2z)

C5=(P3x−Do, P3y+D/4+Do, P3z)

C6=(P3x+W/4, P3y+D/4+Do, P3z)

C7=(P4x+W/4, P4y+Do, P4z)

C8=(P1x, P5y+Do, P1z)

C9=(−P1x, −P1y, P1z+Do)

C10=(P6x+W/2+Do, P6y, P6z+Do)

C11=(P6x+W/2+Do, P6y, P6z−ds)

C12=(P7x+Do, P1y−D/4, P7z)

C13=(P8x+Do, P8y−D/4−Do, P8z)

C14=(P8x−W/4, P8y−D/4−Do, P8z)

C15=(P9x−W/4, P9y−Do, P9z)

C16=(P6x, P10y−Do, P6z)

While the coordinates of four points including two points for each plane with respect to one rotation axis attitude and for two rotation axis attitudes, that is, a total of eight points are measured in the present embodiment, the position of the rotation center line can be calculated by measurement of a minimum of three points with respect to one rotation axis attitude, that is, a total of six points assuming that the planes of the workpiece are perpendicular to each other. When there are two rotation axes, the number of measurement points is a minimum of 12 points.

At the reference-point-coordinate calculating step S11, an equation of a line is obtained from measurement results of two points on a same plane and the coordinate of an intersection of two lines is calculated according to two equations of a line as a reference point coordinate. Calculation of obtaining an equation of a line from two points and calculation of obtaining an intersection of two equations of a line can be achieved by a widely known method. At the rotation-center-position calculating step S15, a position of the rotation-axis center line is calculated using reference point coordinates at two angles with respect to one rotation axis. When a coordinate of the reference point 5 in a case where the C-axis is at 0 degree is P_{A0C0} and a coordinate of the reference point 5 in a case where the C-axis is at 180 degrees is P_{A0C180}, the rotation center position of the C-axis in the present embodiment is calculated as an average of the two coordinate values.

Because the center position of the A-axis is also calculated in addition to the center position of the C-axis in the present embodiment, the procedure returns back to the reference-point setting step S8 to set the reference point 5 for measuring the A-axis center position. At the reference-point setting step S8, one point on the workpiece in a state where the workpiece is projected on a plane perpendicular to the rotation axis to be measured is set as the reference point based on the information set at the workpiece setting step S1.

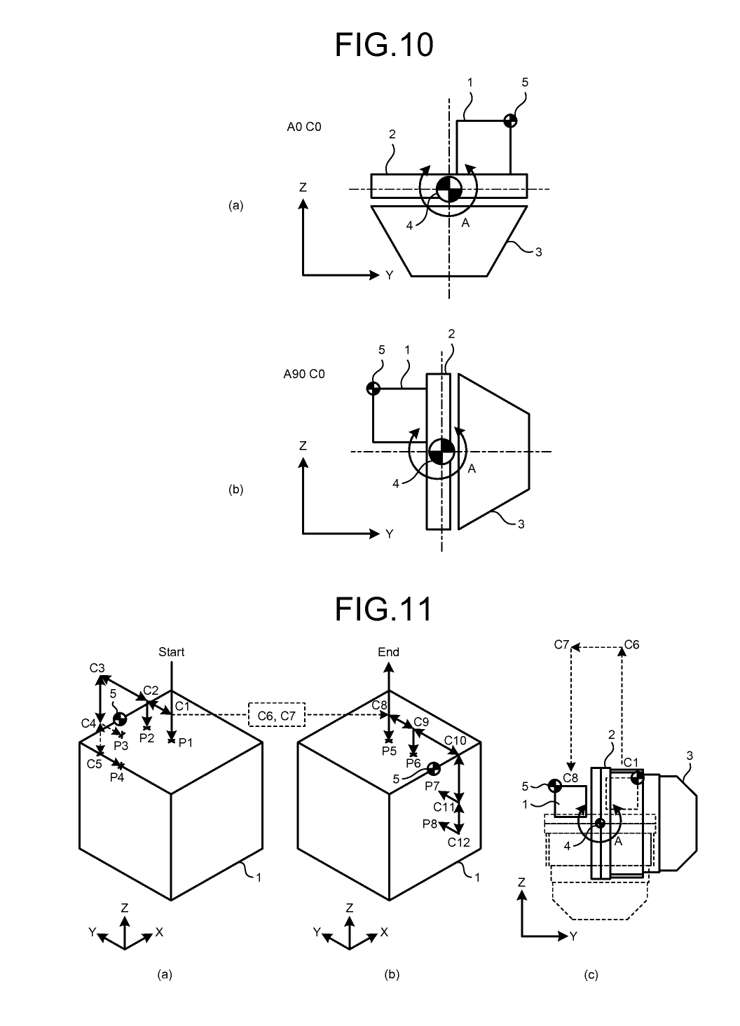

FIG. 10 schematically depict the reference point 5 for measuring a geometric deviation of the A-axis and a position of the reference point 5 resulting from rotation of the rotation axis. FIG. 10(a) depicts a case where the A-axis is at 0 degree and the C-axis is at 0 degree, and FIG. 10(b) depicts a case where the A-axis is at 90 degrees and the C-axis is at 0 degree. In this case, when the workpiece is installed as shown in FIG. 10, the coordinate of the reference point can be specified by the touch probe even in a state where the A-axis is rotated 90 degrees. However, for example, when the workpiece 1 is installed on the −Y side of the A-axis center line, measurement by the touch probe cannot be performed in a state where the A-axis is rotated 90 degrees.

To solve this problem, the error measurement device according to the present embodiment includes a unit that detects a rough installation position of a workpiece, a unit that calculates measurement points on the workpiece required to specify the reference point in a case where the rotation axis is rotated a predetermined angle, and a unit that determines whether the measurement points can be measured by a position measurement function included in the numerical-control machine tool, and, when it is determined that the measurement cannot be performed, changes the reference point, change the predetermined angle of the rotation axis, rotates a rotation axis to which the workpiece is fixed, or changes a fixation position of the workpiece.

A specific example for the multi-axis machine tool described in the present embodiment is explained with reference to FIG. 5. First, at the workpiece approximate-center-position acquiring step S16, a spindle is moved to a rough center position on the workpiece, for example, with a manual pulse handle, and a coordinate value at that time is acquired. In the case of the multi-axis machine tool described in the present embodiment, measurement cannot be performed when the workpiece 1 is located on the −Y side of the A-axis center line and thus, when the sign of a Y-coordinate acquired at the workpiece approximate-center-position acquiring step S16 is negative, the C-axis is rotated 180 degrees to change the position of the workpiece. In this way, the workpiece 1 is moved to the +Y side and therefore the coordinate of the reference point 5 can be specified even in a state where the A-axis is rotated 90 degrees.

The process shown in FIG. 5 is a specific example of the present embodiment, and the present invention is not limited to the process shown in FIG. 5. For example, the workpiece approximate-center-position acquiring step S16 can be achieved by an image sensor or the like, or the installation position of the workpiece can be changed instead of performing the work-table rotating step S17.

At the measurement-point deciding step S9, measurement points required to specify the coordinate of the reference point 5 set at the reference-point setting step S8 are decided. FIG. 11 depict measurement points decided at the measurement-point deciding step S9 and a measurement route thereof. FIGS. 11(a) and 11(b) are perspective views of positions of measurement points on the workpiece 1 and a measurement route (measurement order) thereof, and FIG. 11(c) depicts how the work table unit 2 on which the workpiece 1 is mounted rotates around the A-axis. Each measurement point coordinate Pn=(Pnx, Pny, Pnz) and each corner coordinate Cn=(Cnx, Cny, Cnz) are calculated as follows. In this case, n is a measurement point or corner number. The workpiece following step S18 in the process shown in FIG. 5 is started or measurement is started from a measurement start point that is set substantially at the center over the workpiece and is shifted in the −Z direction. After the coordinate of the first measurement point is measured, the corners and the measurement points are passed in a numerical order. The coordinates of each measurement point and each corner are coordinate values with reference to a design coordinate of the rotation center.

At the coordinate measuring step S10, a three-dimensional coordinate value of each of the measurement points is acquired and then coordinates of the next corner and the next measurement point are sequentially decided based on the acquired coordinate value according to coordinate calculation formulae shown below. When measurement of four points with respect to one rotation axis attitude is completed, the rotation axis is rotated at the rotation-axis rotating step S12 and then the coordinates of measurement points are measured again to calculate the coordinate of the reference point 5. In this case, W is a width (X direction) of the workpiece, D is a depth (Y direction) of the workpiece, H is a height (Z direction) of the workpiece, Zo is a Z-axis machine origin, Ls is a stylus length of the touch probe, and Do is an offset distance from a workpiece surface at the time of movement. The following coordinate formulae are examples in a case where measurement is performed with the A-axis being rotated 90 degrees.

C1=(P1x, P1y, P1z+Do)

C2=(P1x, P1y+D/4, P1z+Do)

C3=(P2x, P2y+D/4+Do, P2z+Do)

if Ls>H

C4=(P2x, P2y+D/4+Do, P2z−(H−Do)/2)

else

C4=(P2x, P2y+D/4+Do, P2z−(Ls−Do)/2)

end

C5=(P3x, P3y+Do, 2P3z−P2z)

C6=(P1x, P1y, Zo)

C7=(P1x, −P4z, Zo)

C8=(P1x, −P4z, P4y+Do)

C9=(P5x, −P3z, P5y+Do)

C10=(P5x, −P2z−Do, P6z+Do)

C11=(P6x, −P2z−Do, P6z−(Ls−Do)/2)

C12=(P7x, P1y−Do, 2P7z−P6z)

At the reference-point-coordinate calculating step S11, an equation of a line is obtained from measurement results of two points on a same plane, and the coordinate of an intersection of two lines is calculated according to two equations of a line as a reference point coordinate. Calculation of obtaining an equation of a line from two points and calculation of obtaining an intersection of two equations of a line can be achieved by a widely known method. At the rotation-center-position calculating step S15, a position of the rotation-axis center line is calculated using reference point coordinates at two angles with respect to one rotation axis. The rotation center position of the A-axis in the present embodiment is calculated as an intersection between a line segment, which is obtained by rotating a line segment connecting the reference point P_{A0C0} in a case where the A-axis is at 0 degree and the reference point P_{A90C0} in a case where the A-axis is at 90 degrees, 45 degrees around the reference point P_{A0C0}, and a line segment, which is obtained by rotating the line segment connecting the reference point P_{A0C0} and the reference point P_{A90C0}, −45 degrees around the reference point P_{A90C0}.

While the method of measuring the rotation center position using the touch probe in a case where a cuboid workpiece is fixed on the work table in the multi-axis machine tool having the A-axis and the C-axis on the side of the workpiece has been explained above, the method can be also applied by persons skilled in the art to a multi-axis machine tool having another axis configuration. In addition, even when the workpiece fixed on the table is not a cuboid, the same method can be applied only by changing the method of measuring the reference point.

The same methods as described in the first embodiment are applied to the processes at the workpiece-installation-error measuring step S4 and the workpiece-installation-error parameter setting step S5. While the case in which the workpiece is a cuboid has been explained in the first embodiment, the present invention is not limited thereto and, also when the workpiece is in a cylindrical shape or other shapes, the present invention can be applied by executing a measurement method corresponding to the shape.

### INDUSTRIAL APPLICABILITY

The error measurement device and the error measurement method according to the present invention are useful in application to a numerical-control machine tool having a translation axis and a rotation axis, and is particularly suitable for a use in a multi-axis machine tool such as a five-axis control machining center to measure errors such as a position and a tilt of a rotation-axis center line and an installation position and a tilt of a workpiece.

### REFERENCE SIGNS LIST

1 workpiece
2 work table unit
3 tilt axis unit
4 rotation center
5 reference point on workpiece
S1 workpiece setting step (workpiece setting unit)
S2 rotation-axis geometric-deviation measuring step (rotation-axis geometric-deviation measurement unit)
S3 geometric-deviation-parameter setting step (geometric-deviation-parameter setting unit)
S4 workpiece-installation-error measuring step (workpiece-installation-error measurement unit)
S5 workpiece-installation-error parameter setting step (workpiece-installation-error parameter setting unit)
S6 rotation-center-position measuring step (rotation-center-position measurement unit)
S7 rotation-center-parameter setting step (rotation-center-parameter setting unit)
S8 reference-point setting step (reference-point setting unit)
S9 measurement-point deciding step (measurement-point decision unit)
S10 coordinate measuring step (coordinate measurement unit)
S11 reference-point-coordinate calculating step (reference-point-coordinate calculation unit)
S12 rotation-axis rotating step (rotation-axis rotation unit)
S13 post-rotation measurement-point calculating step (post-rotation measurement-point calculation unit)
S14 rotation-axis geometric-deviation calculating step (rotation-axis geometric-deviation calculation unit)
S15 rotation-center-position calculating step (rotation-center-position calculation unit)
S16 workpiece approximate-center-position acquiring step (workpiece approximate-center-position acquisition unit)
S17 work-table rotating step (work-table rotation unit)
S18 workpiece following step (workpiece following unit)

1. An error measurement device that measures a position and a tilt of a rotation-axis center line and an installation position and a tilt of a workpiece in a numerical-control machine tool having a translation axis and a rotation axis, the error measurement device comprising:
a rotation-axis geometric-deviation measurement unit that measures a position and a tilt of the rotation-axis center line by measuring a position of a point on a surface of the workpiece fixed;
a geometric-deviation-parameter setting unit that sets the measured position and tilt of the rotation-axis center line in a numerical control device;
a workpiece-installation-error measurement unit that measures an installation position and a tilt of the workpiece with reference to the position of the rotation-axis center line; and
a workpiece-installation-error parameter setting unit that sets the measured installation position and tilt of the workpiece in a numerical control device, wherein
measurement of a position and a tilt of the rotation-axis center line by the rotation-axis geometric-deviation measurement unit and measurement of an installation position and a tilt of the workpiece by the workpiece-installation-error measurement unit can be performed in a same measurement cycle.

2. An error measurement device that measures a position of a rotation-axis center line and an installation position and a tilt of a workpiece in a numerical-control machine tool having a translation axis and a rotation axis, the error measurement device comprising:
a rotation-center-position measurement unit that measures a position of the rotation-axis center line by measuring a position of a point on a surface of the workpiece;
a rotation-center-parameter setting unit that sets the measured position of the rotation-axis center line in a numerical control device;
a workpiece-installation-error measurement unit that measures an installation position and a tilt of the workpiece with reference to the position of the rotation-axis center line; and
a workpiece-installation-error parameter setting unit that sets the measured installation position and tilt of the workpiece in a numerical control device, wherein
measurement of a position of the rotation-axis center line by the rotation-center-position measurement unit and measurement of an installation position and a tilt of the workpiece by the workpiece-installation-error measurement unit can be performed in a same measurement cycle.

3. The error measurement device according to claim 1, wherein
the rotation-axis geometric-deviation measurement unit includes
a reference-point setting unit that defines a shape of the workpiece and one point on the workpiece as a reference point,
a measurement-point decision unit that decides a measurement point on the workpiece required to specify a three-dimensional coordinate of the reference point,
a reference-point-coordinate calculation unit that calculates a three-dimensional coordinate of the reference point based on a plurality of the measurement points on the workpiece, at at least two index angles while indexing the rotation axis by a predetermined angle, and
a rotation-axis geometric-deviation calculation unit that calculates a position and a tilt of a rotation center line of the rotation axis based on a relationship between the index angles and a plurality of the three-dimensional coordinates of the reference point.

4. The error measurement device according to claim 2, wherein
the rotation-center-position measurement unit includes
a reference-point setting unit that defines a shape of the workpiece and one point obtained by projecting the workpiece on a two-dimensional plane perpendicular to the rotation axis as a reference point,
a measurement-point decision unit that decides a measurement point on the workpiece required to specify a two-dimensional coordinate of the reference point,
a reference-point-coordinate calculation unit that calculates a two-dimensional coordinate of the reference point based on a plurality of the measurement points on the workpiece, at at least two index angles while indexing the rotation axis by a predetermined angle, and
a rotation-center-position calculation unit that calculates a position of a rotation center line of the rotation axis based on a relationship between the index angles and a plurality of the two-dimensional coordinates of the reference point.

5. (canceled)

6. (canceled)

7. The error measurement device according to claim 1, further comprising:
a workpiece approximate-center-position acquisition unit that detects a rough installation position of the workpiece; and
a workpiece approximate-center-position acquisition unit that calculates the measurement point on the workpiece required to specify the reference point in a case where the rotation axis is rotated a predetermined angle, wherein
it is determined whether the measurement point can be measured by a position measurement function included in the numerical-control machine tool, and
when it is determined that the measurement point cannot be measured, the reference point is changed, a predetermined tilt of the rotation axis is changed, the rotation axis to which the workpiece is fixed is rotated, or a fixation position of the workpiece is changed.

8. The error measurement device according to claim 1, wherein measurement of the measurement point is performed by a touch probe, and the reference point is set at a corner as distant from a rotation center as possible when the workpiece is a cuboid.

9. An error measurement method of measuring a position and a tilt of a rotation-axis center line of a rotation axis on which a workpiece is installed, and an installation position and a tilt of a workpiece in a numerical-control machine tool having a translation axis and a rotation axis, the error measurement method comprising:
a rotation-axis geometric-deviation measuring step of measuring a position and a tilt of the rotation-axis center line by measuring a position of a point on a surface of the workpiece fixed to the rotation axis;
a geometric-deviation-parameter setting step of setting a correction amount of the measured position and tilt of the rotation-axis center line in a numerical control device;
a workpiece-installation-error measuring step of measuring an installation position and a tilt of the workpiece with reference to the position of the rotation-axis center line; and
a workpiece-installation-error parameter setting step of setting the measured installation position and tilt of the workpiece in a numerical control device, wherein
measurement of a position and a tilt of the rotation-axis center line at the rotation-axis geometric-deviation measuring step and measurement of an installation position and a tilt of the workpiece at the workpiece-installation-error measuring step can be performed in a same measurement cycle.

10. An error measurement method of measuring a position of a rotation-axis center line of a rotation axis on which a workpiece is installed, and an installation position and a tilt of a workpiece in a numerical-control machine tool having a translation axis and a rotation axis, the error measurement method comprising:
a rotation-center-position measuring step of measuring a position of the rotation-axis center line by measuring a position of a point on a surface of the workpiece fixed to the rotation axis;
a rotation-center-parameter setting step of setting a correction amount of the measured position of the rotation-axis center line in a numerical control device;
a workpiece-installation-error measuring step of measuring an installation position and a tilt of the workpiece with reference to the position of the rotation-axis center line; and
a workpiece-installation-error parameter setting step of setting the measured installation position and tilt of the workpiece in a numerical control device, wherein
measurement of a position of the rotation-axis center line at the rotation-center-position measuring step and measurement of an installation position and a tilt of the workpiece at the workpiece-installation-error measuring step can be performed in a same measurement cycle.

11. The error measurement method according to claim 9, wherein
the rotation-axis geometric-deviation measuring step includes
a reference-point setting step of defining a shape of the workpiece and one point on the workpiece as a reference point,
a measurement-point deciding step of deciding a measurement point on the workpiece required to specify a three-dimensional coordinate of the reference point,
a reference-point-coordinate calculating step of calculating a three-dimensional coordinate of the reference point based on a plurality of the measurement points on the workpiece, at at least two index angles while indexing the rotation axis by a predetermined angle, and
a rotation-axis geometric-deviation calculating step of calculating a position and a tilt of a rotation center line of the rotation axis based on a relationship between the index angles and a plurality of the three-dimensional coordinates of the reference point.

12. The error measurement method according to claim 10, wherein
the rotation-center-position measuring step includes
a reference-point setting step of defining a shape of the workpiece and one point obtained by projecting the workpiece on a two-dimensional plane perpendicular to the rotation axis as a reference point,
a measurement-point deciding step of deciding a measurement point on the workpiece required to specify a two-dimensional coordinate of the reference point,
a reference-point-coordinate calculating step of calculating a two-dimensional coordinate of the reference point based on a plurality of the measurement points on the workpiece, at at least two index angles while indexing the rotation axis by a predetermined angle, and
a rotation-center-position calculating step of calculating a position and a tilt of a rotation center line of the rotation axis based on a relationship between the index angles and a plurality of the two-dimensional coordinates of the reference point.

13. (canceled)

14. (canceled)

15. The error measurement method according to claim 9, further comprising a workpiece approximate-center-position acquiring step of acquiring an approximate center position of the workpiece for detecting a rough installation position of the workpiece, and calculating a measurement point on the workpiece required to specify the reference point in a case where the rotation axis is rotated a predetermined angle, wherein
it is determined whether the measurement point can be measured by a position measurement function included in the numerical-control machine tool, and
when it is determined that the measurement point cannot be measured, the reference point is changed, a predetermined tilt of the rotation axis is changed, the rotation axis to which the workpiece is fixed is rotated, or a fixation position of the workpiece is changed.
